(19) United States
(12) Patent Application Publication
(10) Pub. No.: US 2011/0029574 A1
(43) Pub. Date: Feb. 3, 2011

(54) METHOD AND DEVICE FOR RECOGNIZING STRUCTURES IN METADATA FOR PARALLEL AUTOMATED EVALUATION OF PUBLICLY AVAILABLE DATA SETS AND REPORTING OF CONTROL INSTANCES

(76) Inventors: Wolfram Klein, Neubiberg (DE); Gerta Köster, Munchen (DE)

Correspondence Address: King & Spalding LLP, 401 Congress Avenue, Suite 3200, Austin, TX, 78701, US

(21) Appl. No.: 12/919,155

(22) PCT Filed: Feb. 13, 2009
(86) PCT No.: PCT/EP09/51688

§ 371 Date: Aug. 24, 2010

(30) Foreign Application Priority Data
Mar. 7, 2008 (DE) 10 2008 013 002.8

(51) Int. Cl. G06F 17/30

(52) U.S. Cl. 707/802; 707/E17.005

(57) ABSTRACT

In a method for simultaneous observation and analysis of a plurality of data sets, in particular from webcams or sensors published over the Internet, atypical situations can be detected from a plurality of data sets of mostly low quality by producing metadata that are investigated for critical structures. Moreover, atypical situations can be recognized by comparing actual object mass properties of a data set with the target object mass properties of a data set. In this way, for example, human crowds or masses in pedestrian zones, football stadiums or subway stations can be effectively monitored and the large number of freely available internet cameras can be utilized.

### CROSS-REFERENCE TO RELATED APPLICATIONS

This application is a U.S. National Stage Application of International Application No. PCT/EP2009/051688 filed Feb. 13, 2009, which designates the United States of America, and claims priority to DE Application No. 10 2008 013 002.8 filed Mar. 7, 2008. The contents of which are hereby incorporated by reference in their entirety.

### TECHNICAL FIELD

The present invention relates to a method and a device for observing and analyzing a plurality of live data sets, in particular from internet cameras, so-called webcams, which are publicly available over the internet, for recognizing atypical situations and/or critical structures and notifying live data sets which are identified in this way to a control instance.

### BACKGROUND

The simultaneous observation and analysis of a huge number of public live data sets, as are provided by webcams for instance, is to be enabled in such a way that potential dangers are recognized and public authorities can be automatically requested, by way of a so-called “notification”, to manually observe these identified data streams, in particular from webcams. This is a so-called automatic clearing center function, which can already be realized in a conventional fashion.

The worldwide use of the internet and in particular the use of so-called webcams at various, also international, locations, has rendered the observation of these locations and thus also the observation of masses of persons and traffic situations very simple. A large quantity of data of this type is publicly available, but not all of it can be evaluated by the public authorities on account of its large volume. The quality of the data, in particular images, is similarly often inadequate to be able to use direct pattern recognition methods for analyses. The information from webcams of this type is therefore available, but is not used or evaluated at all, or not with sufficient consistency.

An increasing number of webcams is freely accessible in the internet and can be used by a plurality of individuals. No widely applied automated evaluation, by means of public authorities for instance, exists.

The simultaneous manual observation of a plurality of video images of security-relevant public places which are available in the internet is not possible as a result of the data volume. A direct, automatic evaluation by way of conventional pattern recognition using image processing methods is not possible as a result of the poor quality of the images and the long running times of the algorithms.

### SUMMARY

According to various embodiments, a method and a device for observing and analyzing a plurality of live data sets can be provided, in particular from internet cameras which are publicly available over the internet, for recognizing atypical situations and/or critical structures and notifying live data sets which are identified in this way to a control instance, with it being possible for the quality of the data sets to be low. The automatic identification of dangerous situations is to be enabled, as can be caused for instance by the congregation of people or critical crowd flows or as a result of impermissible behavior patterns. The simultaneous analysis of data from a very large number of web cameras or further publicly accessible sensors is to be enabled. Data of this type is usually of poor quality.

According to an embodiment, a method for simultaneously observing and analyzing a plurality of data sets, in particular of internet cameras or sensors which a publicly available by way of the internet, may have the steps of: generating metadata from the data sets; evaluating the metadata in respect of atypical situations and/or critical structures; and notifying a control instance, if atypical situations and/or critical structures are determined.

According to a further embodiment, the method may comprise generating the metadata as a property of object masses, in particular as density, distribution of density, overcrowding, flows, movement directions, speeds and/or behavior pattern of an object mass, associated minimal/maximum average values of an object mass, and/or past, current and future behavior of an object mass. According to a further embodiment, the method may comprise determining target object mass properties of data sets as a function of classes of observation locations and associated types of object masses. According to a further embodiment, the categories of observation sites in a public place, stadium, stadium approach, street, of road users can be partially or completely open areas and/or the natural environment. According to a further embodiment, the types of object masses can be masses of humans, vehicles, bicycles and/or animals. According to a further embodiment, the method may comprise recognizing the atypical situations and/or critical structures by comparing actual object mass properties of a data set with the target object mass properties. According to a further embodiment, the method may comprise recognizing the atypical situations and/or critical structures, in particular as ring formations, regular overcrowding, sharp edges, path formations and/or suddenly dispersing objects in an object mass. According to a further embodiment, the method may comprise recognizing atypical situations and/or critical structures by comparing actual object mass properties of an extract of a data set with the target object mass properties for this extract. According to a further embodiment, the method may comprise recognizing situations and/or structures by filtering the data sets for imaging the metadata as a function of the location and/or the time and/or by means of pattern recognition. According to a further embodiment, the method may comprise automatically identifying the classes of observation locations and/or the types of object masses. According to a further embodiment, the method may comprise automatically recognizing the atypical situations and/or critical structures and/or automated notification of the control instance.

According to another embodiment, a device for the simultaneous observation and analysis of a plurality of data sets, in particular of internet cameras or sensors which are publicly available over the internet, may have facilities for executing a method as described above.

### BRIEF DESCRIPTION OF THE DRAWINGS

The invention is described in more detail with the aid of exemplary embodiments in conjunction with the figures, in which;

FIG. 1 shows the different levels of data collection;

FIG. 2 shows an exemplary embodiment of a method.

### DETAILED DESCRIPTION

The various embodiments differ from conventional pattern recognition approaches in that the pattern recognition, which is referred to as structure recognition in accordance with various embodiments, is already based on metadata, like for instance object mass density, and is not based directly on the video images. A minimal depth of detail generated in this way firstly allows for the parallel observation of a plurality of internet cameras. It is preferred that the video images exhibit specific properties, which are generated for instance from the bird's eye view, so that these images can be easily evaluated. Views from angles with overlaps can in contrast be difficult to evaluate. Most conventional webcams are however suspended at a high level.

It is assumed that the data is transferred to a location where the metadata is generated from the video images. Metadata is understood to mean in particular mass densities of people, distributions of mass densities of people and movement directions and speeds of masses of people. Metadata produces an additional abstraction layer and simplification compared with a direct analysis of the data, which is in particular a video image. A direct analysis of the video images can take place for instance in a conventional fashion by means of pattern recognition, or can be the conventional tracking of people. Metadata has two significant advantages. Metadata can be collected if direct pattern recognition methods are not possible as a result of the quality of the data or would take too long. Metadata represent a simplification of the situation, therefore reduce the flow of information and thus enable the parallel evaluation of a large number of data streams.

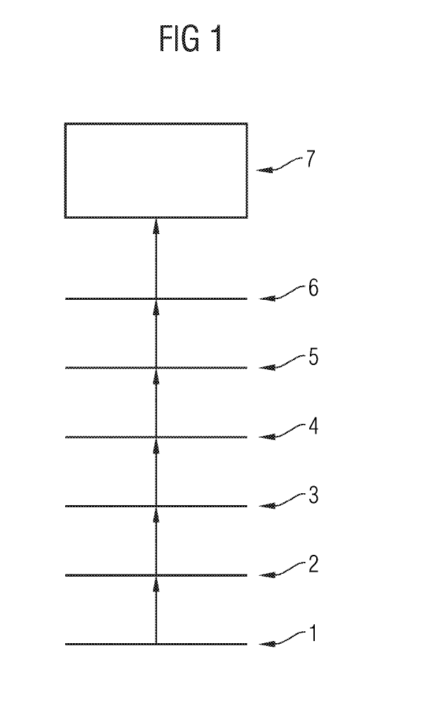

The targeted evaluation of this metadata in terms of atypical situations and/or critical structures, which may indicate danger, is the second step according to an embodiment. If an atypical situation and/or critical structure of this type is recognized, a control instance is notified, for instance a notification is sent to a control center, in which an operator checks the images of the relevant webcam. The different levels of data collection are shown in FIG. 1.

In accordance with various embodiments, very simplified metadata, such as crowd densities for instance, are collected, in which exceptional structures can be recognized, like for instance overcrowding or the forming of rings. If a security-relevant structure is recognized, a switch to manual monitoring takes place in the control center. A plurality of advantages result herefrom. Metadata can also be generated in the case of a poorer image quality. Metadata are very simplified and allow for a rapid analysis of the data. The categorization of observation areas allows for the rapid recognition of atypical structures and situations. Freely available information sources for traffic, like webcams for instance, can now be used. The data can be automatically evaluated. Unusual measurement results can be notified. It is only when a data set is indicated as “worthy of observation” that this specifically identified data set is observed by a human being. An increased efficiency of this type initially renders an observation of the many free webcams possible.

Furthermore, the following advantages result. Forecasts relating to the development can now be calculated in a limited time frame, in other words across several time steps/clock pulses. Crises can therefore be better foreseen and measures more rapidly introduced. The forecasts allow for a first step ranging from response, to the precautionary control of flows of people. Increased security for life and limb is provided. A partial automation of security measures is possible. Furthermore, better statistical statements can also be provided for economic and tourism purposes.

Upon suspicion of a dangerous situation, which is to be recognized in accordance with various embodiments, a “notification” is automatically sent to a public authority and observation by means of an operator is thus requested, so that corresponding measures can be promptly initiated.

According to an embodiment, the generation of metadata takes place as properties of object masses, in particular as density, distribution of the density, crowding, streams, movement direction, speed and/or behavioral pattern of an object mass, associated minimum, maximum, average values or an object mass and/or past or future behavior of an object mass. For each type of object mass, for instance masses of persons, the specific characteristics are to be defined hereby. This can take place for instance by means of the parameters (typical) density of the human crowds or masses, speed (determination of typical minimum/maximum average speeds), movement directions of the masses and typical behavior patterns. Parameters of this type can in each case represent the current point in time, a point in time in the past and/or a prognosis of the future behavior.

According to a further embodiment, a determination of target object mass properties of data sets takes place as a function of categories of observation locations and/or types of object masses. Based on available data sources, such as webcams for instance, these sources are categorized according to observation location and associated types of object masses. More precise suggestions for the categorization of observation locations and flows of road users are made below.

According to a further embodiment, the categories of observation locations, for instance a public place, a stadium, stadium approach, a street and/or the natural environment. The class “public place” can comprise the following properties for instance: the size of the place. The place is only filled with people as an object mass. The people at the location exhibit a slow speed. The people form a typical direction/movement pattern. A further category is a “stadium” for instance. Here the stadium has the following internal properties: a maximum number of people. The stadium is only filled with people. The people exhibit a very slow speed and/or no speed of movement. The category “stadium approach” has the following properties for instance: a typical direction/movement pattern of the people. A maximum density of people exists for each area. Temporally restricted behavior only exists. Category “street”, type “highway”: a highway has several lanes, the motor vehicles exhibit a typical direction/movement pattern. A maximum density of vehicles for each unit of area exists. Type main road: this has a maximum of two lanes. The vehicles exhibit a relatively slow speed. A typical direction/movement pattern of cars exists. A maximum density of vehicles per unit of area exists. Type secondary road: this has one lane, the vehicles exhibit a very slow speed. The vehicles have a typical direction/movement pattern. A maximum density of vehicles exist per unit of area. Similarly, combinations of areas with or without masses of persons are to be automatically evaluated and atypical behavior is notified for instance a) on a subway platform. People are located on the platform. There are no people in the track area. b) football stadium. People are located on seats. There are no people on the other side of the security fence around the pitch. C) Police blockades/demonstrations. People are located in front of the blockades. There are no people on the other side of the blockades. Similarly, free areas are also to be recognized by road users, in other words “ no streams of people” are present, in other words for instance a) webcams with landscape shots, b) building shots, c) weather observations or suchlike. Category “nature”: this has the following properties. There is only a very small number of people. Their speed is very slow. The people form a typical direction/movement pattern.

According to a further embodiment, the object masses are embodied by means of people, vehicles, bicycles and/or animals. Different types of object masses are defined. Further types of object masses may be for instance: streams of people: a) static masses of persons, for instance in a football stadium during a football game, b) determined and rapidly moving masses of persons on their way to/from a football stadium for instance, c) aimlessly wandering masses of persons at significantly fluctuating speeds and directions, at a public festival for instance. d) periodically changing masses of persons on a subway platform with a continuously increasing and/or abruptly falling density of masses of persons in a 10 minute cycle. Traffic: a) Flows of traffic on highways and/or traffic jams are conceivable with a very structured pattern of masses of cars, in other words for instance one, two or multiple lanes, and correspondingly higher speeds. B) A division according to street types takes place.

According to a further embodiment, the atypical situations and/or critical structures are recognized by comparing actual object mass properties of a data set with the target object mass properties of the associated categories and the associated types of object masses. Recognition of so-called atypical situations and/or critical structures for an observation location and/or for an area basically takes place in comparison with the normal data generated by means of classification and/or permissible data. In particular, an atypical behavior and thus exceptional behavior for each type of human masses can similarly be defined, that is to say how said mass should not behave; alternatively the definition of several atypical behavior patterns is possible. a) critical densities of the masses of persons, both excessively low and excessively high, b) excessively high speeds of the human masses, c) chaotic and/or abrupt change in direction. Available data sources, such as webcams, form the starting point. Such sources are categorized in accordance with observation location and associated types of masses of persons with information relating to typical density and typical and permissible behavior. A typical and permissible behavior is walking at a specific speed for instance. Furthermore, non-permissible densities and behavior types are also determined. A comparison of the currently viewed data with normal data and/or permissible data takes place.

According to a further embodiment, recognition of the atypical situations and/or critical structures takes place, in particular as ring formations, regular overcrowding, sharp edges, the formation of paths and/or suddenly dispersing objects in an object mass. This means that in addition to the atypical situations, certain patterns, which are referred to as structures in accordance with the present application, are to be recognized in the metadata. Exceptional structures of the mass of this type can be specified for instance by the number of people in the mass falling over, or accidents for instance. Remarkable structures of this type may therefore indicate danger. To recognize structures of this type, metadata is understood as the function of the location, in other words mapped on the observation area, and the time is mapped on the observation time frame. For instance, the person density is a function of the location at any point in time. It varies in terms of observation area. Structures in the density of people can now be recognized by way of conventional pattern recognition methods of the image processing, which do not form the subject matter of this application. Relevant structures in the metadata for the evaluation may form at a specific point in time. Reference is made to a purely local dependency, in the time response, reference is made to a pure time dependency and/or a dependency on location and time. The following structures are of particular significance: a) ring formation. The forming of a ring indicates for instance an accident in a flow of people. Rings at fixed points in time can be recognized. Similarly, general ring structures, like for instance ellipses, rings that are not completely circular, rings with individuals at the center, should be recognized. b) regular overcrowding in terms of quantity, rhythmic appearance of overcrowding. Rhythmic overcrowding at a fixed point in time indicates wave-type movements in the quantity.

Wave-type structures of this type, which are turbulences, indicate the onset of panic. Regular overcrowding in terms of time alone are however not critical, as a result of the regular arrival of subway trains for instance. c) sharp edges. Sharp edges in a mass indicate a boundary, for instance a fence. Newly appearing edges must either result in a new categorization of the observation area, in other words a building measure must be taken into account, or the newly appearing sharp edges indicate impermissible obstacles. d) path formations. Opposing flows of people form so-called paths in the case of high density environments, with people walking one behind the other. This indicates a significantly increased density of people in which critical situations may occur. e) Suddenly dispersing people. People who were previously packed closely together and now suddenly disperse, indicate an incident of panic. Patterns of this type are to be recognized.

According to a further embodiment, the recognition of atypical structures and/or critical structures by comparing actual object mass properties of an extract of a data set with the target object mass properties of the associated category for this extract section. The permissibility of data does not necessarily apply to the entire observed image of a webcam, but may vary in the observation area. This allows for identification and special observation of special, also critical subareas or extracts of a data set, such as outputs and inputs for instance and the recognition of characteristic structures in the data sets.

According to a further embodiment, situations and/or structures are recognized by filtering the data sets in order to map the metadata as a function of the location and/or time and/or by means of pattern recognition. Methods are used to filter/automatically analyze data sets, which are generated by the webcams at the observation points. The webcams form the metadata, which are the density of people or also density of cars for instance, as a function of the location over the course of time.

According to a further embodiment, an automated recognition of the category of the observation location and the associated type of object mass takes place. It is therefore desirable in one step already to automate the categorization of observation locations. The starting point should be the data/video streams of any webcam from the internet for instance. The aim is to analyze this data, so that an automatic correct choice of the necessary parameters takes place for categorization purposes.

According to a further embodiment, an automated recognition of the atypical situations and/or critical structures and/or an automated notification of the control instance takes place. As a result of the personal previous knowledge and the intrinsic graphical interpretation of the webcam images, one possible method is to map the type of the observed crowds or human masses onto one of the types defined above. Subsequently, a crowd control program will be able to set the corresponding parameter limits and corresponding behavior patterns for this specifically selected type. A crowd control program is the mechanism which enables the automatic recognition of typical situation and/or critical structures. A corresponding atypical, and thus exceptional behavior and/or critical structures can be recognized and thus notified (this corresponds to the manual default type). Alternatively, an automated type selection takes place. This means that after several implemented evaluations of the images of a webcam by means of the preceding method, values which are characteristic of this webcam, such as density, speed or direction of the road user, like masses of persons for instance, can be determined and if the behavior of this observed road user was previously non-critical, said values can likewise be assigned to one of the previously defined types. The corresponding parameter limits and corresponding behavior pattern can be set for this now automatically selected type, atypical behavior and thus exception behavior and/or critical structures can be recognized and thus notified. An assignment of the specific behavior pattern takes place. If the data of a video stream of a web cam is now assigned to a type of crowds or human masses, the corresponding type pattern behavior can be loaded for this scenario. These are a) the minimum/maximum and average values of the parameters, b) density of the crowds or human masses, c) speed, with the typical minimum/maximum average speed being defined, d) the direction, and e) typical pattern within the mass, and its f) past and/or future behavior. Automated recognition of atypical behavior patterns. The just described assignment to a specific behavior pattern and the comparison of the actual situation with the assigned pattern enables an atypical and/or exceptional behavior and/or a critical structure to be automatically recognized. This can be notified at corresponding points so that measures can be taken there.

The behavior, for instance of a crowd or human masses, can be automatically evaluated and forwarded for manual observation in the event of suspicion.

FIG. 1 shows the different levels of data collection. The level 1 corresponds here to reality. This is conveyed into an image 2 of the reality by means of imaging, for instance by means of video. A level 3 ensues by means of the method of image recognition and by means of feature extraction, in which level the properties, like for instance people, cars or items of baggage or the properties thereof, can be detected.

Variables or metadata based on level 3, like for instance density of people, can be transferred into a level 4 by means of number algorithms, evaluation algorithms, in respect of the density of people for instance.

According to an embodiment, a structure level 5 is now generated from the meta data of the level 4 by means of structure recognition, in other words by means of filtering the data sets in order to map the metadata as a function of the location and/or time and/or by means of conventional pattern recognition from the image processing, said structure level 5 likewise being referred to as a situation level 5.

Atypical situations and/or critical structures are now detected at a level 6. The recognition of atypical situations and/or critical structures basically takes place by comparing actual object mass properties with permissible object mass properties, for instance by querying atypical situations and/or critical structures from a database. Atypical situations and/or critical structures can be recognized in this way in the metadata, like rings for instance, which are generated for instance as a form of density distribution of a crowd or human masses. Further atypical situations and critical structures are likewise possible. Atypical situations and critical structures can be regular overcrowding, sharp edges, paths and/or suddenly dispersing objects in an object mass.

The notification of a control instance 7, in the event of atypical situations and critical structures occurring, takes place as the last step. Structures are formed from the metadata. Critical structures are determined by means of comparison. A control instance is notified in the presence of critical structures.

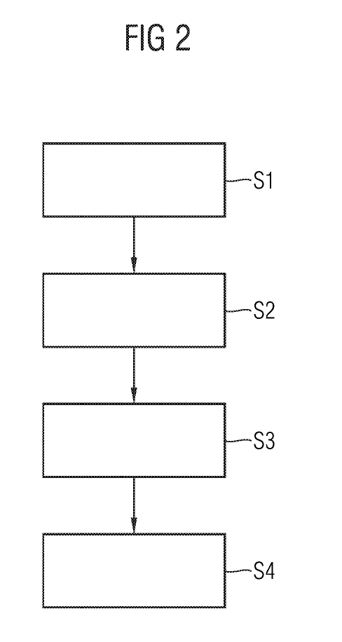

FIG. 2 discloses a simple exemplary embodiment of a complete method. In an optional step 1, a new webcam is set up at a public place in a pedestrianized area. In step S2, a categorization of the data stream takes place, either by hand or already automatically by comparing with pattern data sets. For instance, the categorization takes place as a public place, in which the pedestrians are the permissible road users and the permissible density of people is two people per square meter for instance. With a third step S3, a continuous analysis takes place by a continuous density measurement being executed. A continuous comparison of the determined densities takes place with permissible ranges. With a step S4, a notification takes place in the event of a hazard arising, which can be referred to as “notification”. When the permissible range is left, an automatic notification to an authority or clearing center respectively, takes place. A notification of this type can indicate that the space is overcrowded. The data flow generated by the webcam is now observed by means of an operator, who identifies the corresponding URL (Uniform Resource Locator) of the webcam.

With a plurality of internet cameras, the different observation scenarios, in other words observation locations and types of object masses, are initially classified and evaluated according to this classification, in a clearing center for instance and the result is forwarded to the responsible authority on suspicion of danger.

What is claimed is:

1. A method for simultaneously observing and analyzing a plurality of data sets comprising:
generating metadata from the data sets;
evaluating the metadata in respect of at least one of atypical situations and critical structures;
notifying a control instance, if at least one of atypical situations and critical structures are determined.

2. The method according to claim 1, further comprising
generating the metadata as a property of object masses.

3. The method according to claim 2, comprising
determining target object mass properties of data sets as a function of classes of observation locations and associated types of object masses.

4. The method according to claim 3, wherein
the categories of observation sites in a public place, stadium, stadium approach, street, of road users are at least one of partially or completely open areas and a natural environment.

5. The method according to claim 3, wherein
the types of object masses are at least one of masses of humans, vehicles, bicycles and animals.

6. The method according to claim 3, comprising
recognizing at least ore of the atypical situations and critical structures by comparing actual object mass properties of a data set with the target object mass properties.

7. The method according to claim 2, comprising
recognizing at least one at the atypical situations and critical structures in an object mass.

8. The method according to claim 3, comprising
recognizing at least one of atypical situations and critical structures by comparing actual object mass properties of an extract of a data set with the target object mass properties for this extract.

9. The method according to claim 2, comprising
recognizing at least one of situations and structures by filtering the data sets for imaging the metadata as a function of at least one of the location, the time, and by means of pattern recognition.

10. The method according to claim 3, comprising
automatically identifying at one of the classes of observation locations and the types of object masses.

11. The method according to claim 1, comprising
automatically recognizing at least one of the atypical situations and critical structures.

12. A device for the simultaneous observation and analysis of a plurality of data sets, comprising
means for generating metadata from the data sets;
means for evaluating the metadata in respect of at least one atypical situations and critical structures;
means for notifying a control instance, if at least one of atypical situation and critical structures are determined.

13. The device according to claim 12, wherein the data sets are provided by internet cameras or sensors which are publicly available by way of the Internet.

14. The device according to claim 12, wherein the device is further operable to generate the metadata as a property of object masses comprising at least one of: density, distribution of density, overcrowding, flows, movement directions, speeds and/or behavior pattern of an object mass, associated minimal/maximum average values of an object mass, and past, current and future behavior of an object mass.

15. The device according to claim 14, comprising
determining target object mass properties of data sets as a function of classes of observation locations and associated types of object masses.

16. The method according to claim 1, wherein the data sets are provided by internet cameras or sensors which are publicly available by way of the Internet.

17. The method according to claim 2, wherein the property of object masses comprises at least one of: density, distribution of density, overcrowding, flows, movement directions, speeds and/or behavior pattern of an object mass, associated minimal/maximum average values of an object mass, and past, current and future behavior of an object mass.

18. The method according to claim 7, wherein the at least one of the atypical situations and critical structures are recognized as at least one of ring formations, regular overcrowding, sharp edges, path formations and suddenly dispersing objects in an object mass.

19. The method according to claim 1, comprising
automatically recognizing at least one of the atypical situations and critical structures, and further comprising an automated notification of the control instance.

20. The method according to claim 1, comprising
an automated notification of the control instance.
